(19) United States
(12) Patent Application Publication
(10) Pub. No.: US 2011/0183220 A1
(43) Pub. Date: Jul. 28, 2011

(54) METHOD OF PURGING FOR FUEL CELL

(75) Inventors: Joong Myeon Bae, Daejeon (KR); Dong Ryul Lee, Seoul (KR); Byung Sun Hong, Seongnam (KR); Sung Jin Oh, Yongin (KR); Seung Ho Baek, Guri (KR)

(73) Assignees: CT & T Co., Ltd., Dangjin-gun (KR); Korea Advanced Institute of Science and Technology, Daejeon (KR); FuelCellPower Inc.., Seongnam (KR)

(21) Appl. No.: 12/595,474

(22) PCT Filed: May 21, 2007
(86) PCT No.: PCT/KR2007/002466

§ 371 Date: Jan. 6, 2010

(51) Int. Cl. H01M 8/06

(52) U.S. Cl. 429/414

(57) ABSTRACT

Disclosed herein is a method of purging a fuel cell, by which water present in fuel cell stacks is discharged outside the fuel cell stacks together with gas by opening and closing a purge valve, including: conducting a short-period purge several times using the purge valve; and conducting a long-period purge once using the purge valve, wherein the short-period purge and the long-period purge are repeatedly conducted. The method of purging a fuel cell is advantageous in that the short-period purge is conducted several times using a purge valve and then the long-period purge is conducted once, and these short-period purges and the long-period purge are repeatedly conducted, so that the problems occurring when only a short-period purge or only a long-period purge is conducted can be solved, with the result that the efficiency and performance of the fuel cell are improved and the fuel cell can be stably operated.

### TECHNICAL FIELD

The present invention relates to a method of purging a fuel cell, and, more particularly, to a method of purging a fuel cell, which can improve the efficiency and performance of the fuel cell.

### BACKGROUND ART

Generally, assuming that a battery is an energy storage device, a fuel cell may be referred to as a device for converting chemical energy into electrical energy.

That is, a fuel cell produces electricity through a process of bonding hydrogen and oxygen into water.

Further, unlike engines or turbines, fuel cells do not produce nitrogen oxides or sulfur because they do not burn fuel.

Now, fuel cells are variously used as an alternative power source. Hereinafter, for the convenience of explanation, from among the various types of fuel cells, a polymer electrolyte fuel cell will be chiefly described.

The polymer electrolyte fuel cell is used as power sources for pollution-free automobiles, electric power generation systems for home use, mobile communication equipment, military equipment, medical appliances, and the like because it has high output density and energy conversion efficiency, can be operated at a low temperature of 80° C. or less, and can be miniaturized and hermetically sealed.

In this polymer electrolyte fuel cell, the output of electrical energy depends on the degree to which protons, which are hydrogen ions, pass through a polymer membrane, called Nafion™. The polymer membrane must be suitably hydrated in order to allow hydrogen ions to pass therethrough.

The hydration of the polymer membrane is conducted by humidifying the reaction gases introduced into the anode and cathode of the polymer electrolyte fuel cell using an additional humidifier such that the relative humidity of the polymer electrolyte fuel cell is 100% at the operation temperature of fuel cell stacks.

During the operation of the polymer electrolyte fuel cell, water is produced as a reaction product at the cathode, and an excessive amount of water can exist in the polymer electrolyte fuel cell.

Since the counter diffusion of hydrogen ions in the anode can occur through the polymer membrane due to the excessive amount of water produced at the cathode, it is important in the operation of the polymer electrolyte fuel cell to control the amount of water at the cathode and anode using the polymer membrane as a boundary.

That is, when the electrodes including the anode and cathode are insufficiently humidified, the polymer membrane is dehydrated, and thus the resistance value of the polymer membrane is increased. However, since the movement of protons is prevented due to the increase in the resistance value of the polymer membrane, there is a problem in that the electrical efficiency of the polymer electrolyte fuel cell is decreased.

Further, since the movement of gas to the electrode and the diffusion of protons are prevented due to the excessive amount of water, there are problems in that the stability of the polymer electrolyte fuel cell and the efficiency with which chemical energy is converted into electrical energy are decreased.

Generally, in the polymer electrolyte fuel cell, the problem of the excessive amount of water (hereinafter, referred to as “a flooding phenomenon”) is more important than the problem of dehydration.

In particular, in an operational environment in a high current region, a reaction product is excessively produced at the cathode, and the supply of gas to the catalyst layer and the diffusion of protons to the polymer membrane are inhibited due to drops of water, when water is in excess, so that the performance of the entire fuel cell stacks is deteriorated.

Moreover, since water is not uniformly distributed in unit cells present in the fuel cell stacks, the performance of some of the unit cells may be deteriorated, and thus normal operation becomes difficult.

As such, since the reaction efficiency of the polymer electrolyte fuel cell is decreased and the stable operation thereof is difficult due to the flooding phenomenon occurring in the polymer electrolyte fuel cell, it is absolutely required to discharge the excessive amount of water to the outside of the fuel cell stacks.

Conventional methods of discharging water from a fuel cell may include a structural method and a purge method.

The structural method is a method of easily discharging water from fuel cells depending on pressure drop and flow rate by designing the flow channel of a separation plate in a serpentine shape by which water is easily discharged.

The purge method is a method of accelerating the discharge of water in a mixed form of water and gas using a purge valve provided at the rear end of the fuel cell stack.

This purge method includes a short-period purge method and a long-period purge method.

FIG. 1 is a graph showing a purge signal according to a conventional short-period purge method. Here, the purge conditions are a purge period of 1 rev/5˜60 sec and a purge duration time of 0.5˜2 sec.

As such, in the short-period purge method, a purge valve is frequently opened for a short time. The short-period purge method is advantageous in that water is discharged little by little, thus enabling the fuel cell to produce a normal output, but is problematic in that water cannot be completely discharged for a short time, so that water remains in the fuel cell, thereby deteriorating the performance of the fuel cell due to the remaining water.

FIG. 2 is a graph showing a purge signal according to a conventional long-period purge method. Here, the purge conditions are a purge period of 1 rev/10 min and a purge duration time of 3 sec.

As such, in the long-period purge method, a purge valve is opened for a relatively long time (3 sec or more), but is opened once approximately every 10 minutes in consideration of fuel consumption. The long period is problematic in that, since the purge valve is opened for a long time, fuel consumption is increased.

### DISCLOSURE OF INVENTION

### Technical Problem

Accordingly, the present invention has been made keeping in mind the above problems occurring in the prior art, and an object of the present invention is to provide a method of purging a fuel cell, which can improve the efficiency and performance of the fuel cell by suitably combining a short-period purge method with a long-period purge method.

### Technical Solution

In order to accomplish the above object, the present invention provides a method of purging a fuel cell, by which water present in fuel cell stacks is discharged outside the fuel cell stacks together with gas by opening and closing a purge valve, including: conducting a short-period purge several times using the purge valve; and conducting a long-period purge once using the purge valve, wherein the short-period purge and the long-period purge are repeatedly conducted.

Here, in the long-period purge, the purge valve is opened once every 2˜20 minutes.

In this case, the purge valve is opened for 1˜10 seconds.

Alternatively, in the long-period purge, the purge valve may be opened once every 10 minutes, and the purge valve may be opened for 3 seconds.

Further, in the short-period purge, the purge valve is opened once every 1˜60 seconds.

In this case, the purge valve is opened for 0.5˜3 seconds.

Alternatively, in the short-period purge, the purge valve is opened once every 10˜15 seconds, and the purge valve is opened for 1˜2 seconds.

### Advantageous Effects

According to the present invention, a short-period purge is conducted several times using a purge valve and then a long-period purge is conducted once, and these short-period purges and long-period purges are repeatedly conducted, so that the problems occurring when only short-period purges or only long-period purges are conducted can be solved, with the result that the efficiency and performance of the fuel cell are improved and the fuel cell can be stably operated.

### BRIEF DESCRIPTION OF THE DRAWINGS

FIG. 1 is a graph showing a purge signal according to a conventional short-period purge method;

FIG. 2 is a graph showing a purge signal according to a conventional long-period purge method;

FIG. 3 is a graph showing a purge signal of a fuel cell according to the present invention; and

FIGS. 4 to 9 are graphs showing experimental data for deducing optimal values in the short-period purge according the present invention.

### BEST MODE FOR CARRYING OUT THE INVENTION

Hereinafter, preferred embodiments of the present invention will be described in detail with reference to the attached drawings.

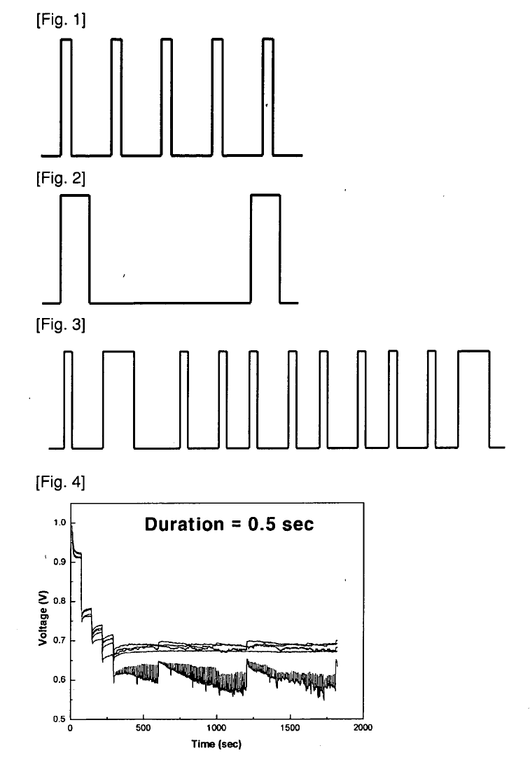

FIG. 3 is a graph showing a purge signal of a fuel cell according to the present invention.

As shown in FIG. 3, the purge of the fuel cell is conducted by opening and closing a purge valve (not shown). The purge valve is opened several times for the short-period purge and is then opened once for the long-period purge. These short-period purges and long-period purges are repeatedly conducted.

In this case, in the long-period purge, the purge valve may be opened once every 2˜20 minutes, and the purge duration time of the purge valve may be 1˜10 seconds.

Preferably, the purge valve may be opened once every 10 minutes, and the purge duration time of the purge valve may be 3 seconds.

Hereinafter, the optimal values in the short-period purge will be deduced through various experiments in a state in which the values in the long-period purge are fixed as above.

First, in the experiment, purge conditions in the long-period purge are fixed at a purge period of 1 rev/10 min, and a purge duration time of 3 sec.

The experiment is conducted six times at purge conditions in the short-period purge of purge periods of 1 rev/10 sec, 1 rev/20 sec and 1 rev/60 sec and purge duration times of 1 sec and 0.5 sec.

Further, the experiment is conducted in a state in which electric current is maintained at 40 A for 30 minutes after increasing the electric current from 0 A to 40 A by 10 A.

FIGS. 4 to 9 are graphs showing experimental data for deducing optimal values in the short-period purge according to the present invention.

FIG. 4 shows the results obtained when the purge valve is opened for 0.5 sec and the purge period is 1 rev/10 sec, and FIG. 5 shows the results obtained when the purge valve is opened for 1 sec and the purge period is 1 rev/10 sec.

From the experimental results shown in FIGS. 4 and 5, it can be seen that the purge duration time must be at least 1 sec or more when the purge period is 1 rev/10 sec.

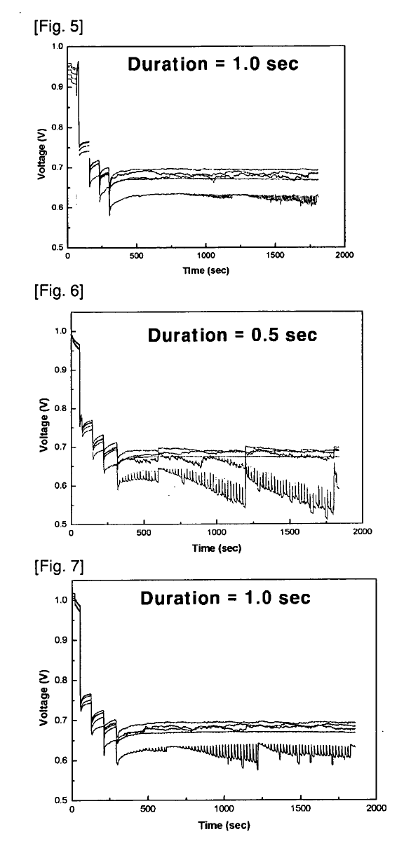

Further, FIG. 6 shows the results when the purge valve is opened for 0.5 sec and the purge period is 1 rev/20 sec, and FIG. 7 shows the results when the purge valve is opened for 1 sec and the purge period is 1 rev/20 sec.

From the experimental results shown in FIGS. 6 and 7, it can be seen that when the purge duration time is 0.5 sec, the voltage drop is gradually increased, and, when the purge duration time is 1 sec, the width of the voltage drop is maintained constant.

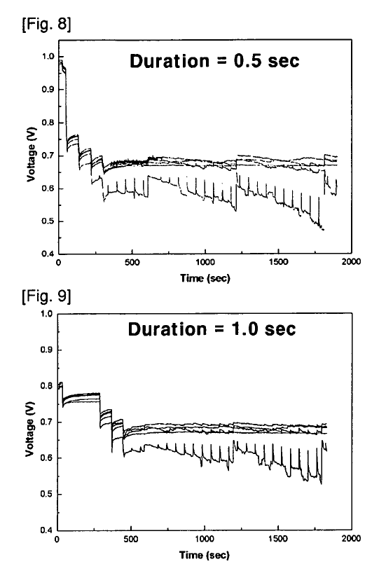

Further, FIG. 8 shows the results when the purge valve is opened for 0.5 sec and the purge period is 1 rev/60 sec, and FIG. 9 shows the results when the purge valve is opened for 1 sec and the purge period is 1 rev/60 sec.

From the experimental results shown in FIGS. 8 and 9, it can be seen that voltage drop occurs regardless of the purge duration time when the purge period is 1 rev/60 sec.

As described above, from the experimental results shown in FIGS. 4 to 9, it can be seen that the efficiency and performance of the fuel cell is most stable when the purge period is fixed at 1 rev/10 min and the purge duration time is fixed at 3 sec in the long-period purge and when the purge period is fixed at 1 rev/10˜15 sec and the purge duration time is fixed at 1˜2 sec in the short-period purge.

1. A method of purging a fuel cell, by which water present in fuel cell stacks is discharged outside the fuel cell stacks together with gas by opening and closing a purge valve, comprising:
conducting a short-period purge several times using the purge valve; and
conducting a long-period purge once using the purge valve,
wherein the short-period purge and the long-period purge are repeatedly conducted.

2. The method of purging a fuel cell according to claim 1, wherein, in the long-period purge, the purge valve is opened once every 2˜20 minutes.

3. The method of purging a fuel cell according to claim 2, wherein, in the long-period purge, the purge valve is opened for 1˜10 seconds.

4. The method of purging a fuel cell according to claim 1, wherein, in the long-period purge, the purge valve is opened once every 10 minutes, and the purge valve is opened for 3 seconds.

5. The method of purging a fuel cell according to claim 1, wherein, in the short-period purge, the purge valve is opened once every 1˜60 seconds.

6. The method of purging a fuel cell according to claim 5, wherein, in the short-period purge, the purge valve is opened for 0.5˜3 seconds.

7. The method of purging a fuel cell according to claim 1, wherein, in the short-period purge, the purge valve is opened once every 10˜15 seconds, and the purge valve is opened for 1˜2 seconds.
